(19) United States
(12) Patent Application Publication
(10) Pub. No.: US 2016/0171722 A1
(43) Pub. Date: Jun. 16, 2016

(54) METHOD, DEVICE, AND ELECTRONIC DEVICE FOR BACKGROUND DISPLAY

(71) Applicant: Xiaomi Inc., Beijing (CN)

(72) Inventors: Wenlin WANG, Beijing (CN); Wei HAN, Beijing (CN); Yuzhen WAN, Beijing (CN)

(21) Appl. No.: 15/051,253

(22) Filed: Feb. 23, 2016

Related U.S. Application Data
(63) Continuation of application No. PCT/CN2014/089322, filed on Oct. 23, 2014.

(30) Foreign Application Priority Data
May 15, 2014 (CN) 201410206706.3

(51) Int. Cl. G06T 11/00; G09G 5/38; G06T 7/00; G06F 3/0481; G06F 3/0482; G06F 3/0484

(52) U.S. Cl. CPC G06T 11/001; G06F 3/0482; G06F 3/04845; G06T 7/004; G06F 3/04817; G09G 5/38

(57) ABSTRACT

A background display method includes determining a position of a target element in a grid view according to attribute information of the target element and attribute information of adjacent elements. The target element is one of a plurality of elements displayed according to the grid view. The method further includes searching a background pattern configuration file according to the position of the target element to determine background pattern information corresponding to the target element and displaying a background pattern of the target element according to the background pattern information corresponding to the target element.

### CROSS REFERENCE TO RELATED APPLICATIONS

This application is a Continuation of International Application No. PCT/CN2014/089322 with an international filing date of Oct. 23, 2014, which is based upon and claims priority to Chinese Patent Application No. 201410206706.3, filed on May 15, 2014, the entire contents of both of which are incorporated herein by reference.

### TECHNICAL FIELD

The present disclosure generally relates to electronic display and, more particularly, to a method, device, and electronic device for background display.

### BACKGROUND

In the field of electronic display, elements are usually displayed in a grid view, such as GridView display. In the grid view, each element may be arranged horizontally or vertically, which forms a grid-type two-dimensional element distribution interface. A plurality of elements of the grid view can be displayed in an interface at the same time. However, due to the large number of elements, limitation of screen size, interface aesthetics and other reasons, the display interface may also display a part of the elements of the grid view, with other elements displayed according to a user's command when turning a page or sliding.

A conventional display method uses the same background pattern for each element in the grid view. Alternatively, each element in the grid view may be provided with a background pattern for aesthetic reasons. For example, developers may set the same background pattern for virtual keys in the same grid view. Sometimes, to obtain a more vivid interface, the developers may further designate, in program codes, different background patterns for different virtual keys. When displaying the interface, the background pattern designated for the virtual key in the interface is directly searched and displayed.

### SUMMARY

In accordance with the present disclosure, there is provided a background display method including determining a position of a target element in a grid view according to attribute information of the target element and attribute information of adjacent elements. The target element is one of a plurality of elements displayed according to the grid view. The method further includes searching a background pattern configuration file according to the position of the target element to determine background pattern information corresponding to the target element and displaying a background pattern of the target element according to the background pattern information corresponding to the target element.

Also in accordance with the present disclosure, there is provided an electronic device including one or more processors and a non-transitory computer-readable storage medium storing instructions. The instructions, when executed by the one or more processors, cause the one or more processors to determine a position of a target element in a grid view according to attribute information of the target element and attribute information of adjacent elements. The target element is one of a plurality of elements displayed according to the grid view. The instructions further cause the one or more processors to search a background pattern configuration file according to the position of the target element to determine background pattern information corresponding to the target element and display a background pattern of the target element according to the background pattern information.

Also in accordance with the present disclosure, there is provided a non-transitory computer-readable storage medium storing instructions. The instructions, when executed by one or more processors of an electronic device, cause the electronic device to determine a position of a target element in a grid view according to attribute information of the target element and attribute information of adjacent elements. The target element is one of a plurality of elements displayed according to the grid view. The instructions further cause the electronic device to search a background pattern configuration file according to the position of the target element to determine background pattern information corresponding to the target element and display a background pattern of the target element according to the background pattern information corresponding to the target element.

It should be understood that both the foregoing general description and the following detailed description are exemplary and explanatory only, and are not to limit the present disclosure.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart of a background display method according to an exemplary embodiment.

FIG. 2 is a schematic diagram of a grid view according to an exemplary embodiment.

FIG. 3 is a schematic diagram of a grid view according to an exemplary embodiment.

FIG. 4 is a schematic diagram of a grid view according to an exemplary embodiment.

FIG. 5 is a schematic diagram of a background display device according to an exemplary embodiment.

FIG. 6 is a schematic diagram of a background display device according to an exemplary embodiment.

FIG. 7 is a block diagram of an electronic device according to an exemplary embodiment.

### DETAILED DESCRIPTION

Embodiments consistent with the present disclosure include a method, device, and electronic device for background display.

The exemplary embodiments are illustrated hereinafter in detail, examples of which are illustrated in the accompanying drawings. When the following description relates to the accompanying drawings, unless otherwise indicated, the same numerals in different figures indicate the same or like elements. The described implementations illustrated in the following exemplary embodiments do not represent all implementations consistent with the present disclosure. Rather, they are only examples of apparatuses and methods consistent with the appended claims and aspects of the present disclosure.

Methods consistent with embodiments of the disclosure may be implemented in an electronic device for displaying a background pattern of elements in a list view or in a grid view. The electronic device may be a smart phone, a tablet computer, a television, an e-book reader, or other smart devices.

FIG. 1 is a flow chart of an exemplary background display method 100 consistent with embodiments of the present disclosure.

As shown in FIG. 1, at 102, a position of a target element in a grid view is determined according to attribute information of the target element and adjacent elements. The target element is one of several elements displayed according to the grid view. The position of the target element in the grid view may include an arranging position of the target element among all elements included in the grid view, or the arranging position of the target element among elements of a sub-list in the grid view.

At 104, a background pattern configuration file is searched according to the position of the target element in the grid view, and background pattern information corresponding to the target element is determined. The background pattern configuration file includes a corresponding relation between each position in the grid view and the background pattern information of that position. Each background pattern configuration file includes an ID. The elements in a grid view may correspond to the same background pattern configuration file, or to different background configuration files. For example, every ten elements may correspond to one background configuration file.

At 106, a background pattern of the target element is displayed according to the background pattern information. The background pattern information is information used for indicating a corresponding background pattern, such as a label of the corresponding background pattern or a storing position of the background pattern, etc.

Since an electronic device screen has a limited size, the number of positions in the grid view is limited. The developer only needs to designate background pattern information for each position in the grid view, instead of designating the background pattern information for each element in the grid view. Therefore, the workload of the developer is reduced.

Details of the background display method 100 consistent with embodiments of the present disclosure are described below.

According to the disclosure, an element has corresponding attribute information. Attributes of an element include a type and a background label. A background label of an element is used to indicate the background pattern configuration file corresponding to the element. An electronic device may obtain the type of the target element via an adapter. Determining the position of the target element in the grid view (102) includes determining a horizontal position and a vertical position of the target element.

In some embodiments, when determining the horizontal position of the target element in the grid view, the electronic device determines the correlation between the target element and a first element and the correlation between the target element and a second element. A correlation between two elements includes whether the attribute information of the two elements is the same or different. The first element is an element that is nearest to the target element among those elements on the left side of the target element. The second element is an element that is nearest to the target element among those elements on the right side of the target element.

In some embodiments, if the attribute information of the first element and the attribute information of the target element are the same, the correlation between the two elements is “same.” On the other hand, if the attribute information of the first element and the attribute information of the target element are different, the correlation between the first element and the target element is “different.” In the present disclosure, the attribute information of the first element and target element being the same means that the target element and the first element have the same type and the same background label. If any one of the type or the background label is different, then the attribute information of the target element and the attribute information of the first element are considered different. The method for determining the correlation between the second element and the target element is similar.

If there is no first element before, i.e., on the left of, a current element, i.e., a target element, the attribute information of the first element is null, or the attribute information of the first element cannot be obtained. When the attribute information of the first element is null, it can be determined that the attribute information of the target element is different from the attribute information of the first element, which does not actually exist. That is, the correlation between the target element and the first element is “different.” When the attribute information of the second element is null, there is no element after, i.e., on the right of, the target element. As a result, it is determined that the attribute information of the target element is different from the attribute information of the second element, which does not actually exist.

Afterwards, the electronic device searches for a corresponding relation between the correlation and the horizontal position of the target element in the grid view, according to the correlation between the target element and the first element and the correlation between the target element and the second element, to determine the horizontal position of the target element in the grid view.

When determining the vertical position of the target element in the grid view, the electronic device determines the correlation between the target element and a third element and the correlation between the target element and a fourth element. The third element is an element that is nearest to the target element among those elements above the target element. The fourth element is an element that is nearest to the target element among those elements below the target element.

The method for determining the correlation between the target element and the third element and the correlation between the target element and the fourth element is similar to the method for determining the correlation between the target element and the first element and the correlation between the target element and the second element, and thus is not repeated here.

According to the present disclosure, if the attribute information of the third element and the attribute information of the target element are the same, the correlation between the third element and the target element is “same.” If there is no third element above the current element, the attribute information of the third element is null, or the attribute information of the third element cannot be obtained, it is considered that the correlation is “different.” The method for determining the correlation between the fourth element and the target element is similar.

Afterwards, the electronic device searches for a corresponding relation between the correlation and the vertical position of the target element in the grid view, according to the correlation between the target element and the third element and the correlation between the target element and the fourth element, to determine the vertical position of the target element in the grid view.

For example, if the electronic device is a smart phone, and the elements are icons displayed according to a grid view in the smart phone, the icons are displayed in a Z-type order from left to right and from top to bottom. That is, the icons are numbered one by one from the first icon in the first line from left to right in the grid view. When the last icon in the line is numbered, the first icon at the left end of the next line is numbered next.

The icons included in the grid view may be divided into different types. For example, the grid view may include two types of icons, one being operable icons such as startup icons of applications, the other being inoperable icons such as static display images. The attribute information of each icon includes its own type and the label of the corresponding background pattern configuration file.

To determine the horizontal position of the currently displayed target icon in the grid view, the smart phone first obtains the number currentPos of the target icon, and then determines whether the type and the label of the corresponding background pattern configuration file of the icon numbered currentPos−1 in the grid view, i.e., the first icon, are the same as the type and the label of the corresponding background pattern configuration file of the target icon, respectively. The smart phone acquires the detecting result as the correlation between the target icon and the first icon. Similarly, the smart phone determines whether the type and the label of the corresponding background pattern configuration file of the icon numbered currentPos+1 in the grid view, i.e., the second icon, are the same as the type and the label of the corresponding background pattern configuration file of the target icon, respectively, and acquires the detecting result as the correlation between the target icon and the second icon.

As described above, the correlation between two icons is “same” only when the type and the label of the corresponding background pattern configuration file of the two icons are both the same. If any one of the type or the label of the corresponding background pattern configuration file of the two icons is different, then the correlation between the two icons is “different.”

The smart phone may search the corresponding relation between the correlation and the horizontal position of the target icon in the grid view, according to the correlation between the target icon and the first icon and the correlation between the target icon and the second icon, to determine the horizontal position of the target icon in the grid view.

Assume the target icon has four types of horizontal positions in the grid view: M, F, L, and S. M means that the target icon is in a middle position among a plurality of adjacent icons of the same type displayed in the same line in the grid view (middle). F means that the target icon is in a first position among a plurality of adjacent icons of the same type displayed in the same line in the grid view (first). L means that the target icon is in the last position among a plurality of adjacent icons of the same type displayed in the same line in the grid view (last). S means that the target icon has no adjacent icons of the same type either on its left or right in the grid view (single). The relation between the correlations and the horizontal position of the target icon is shown in Table 1.

TABLE 1

| Correlation between | | |
|---|---|---|
| target icon and | Correlation between target | Horizontal position of |
| first icon | icon and second icon | target icon |
| same | same | M |
| same | different | L |
| different | same | F |
| different | different | S |

The vertical position of the currently displayed target icon in the grid view can be determined using a method similar to that for determining the horizontal position. Specifically, the smart phone first obtains the number currentPos of the target icon, and then determines whether the type and the label of the corresponding background pattern configuration file of the icon numbered currentPos−numcols (numcols is a total number of columns in the grid view) in the grid view, i.e., the third icon, are the same as the type and the label of the corresponding background pattern configuration file of the target icon, respectively. The smart phone acquires the detecting result as the correlation between the target icon and the third icon. Similarly, the smart phone determines whether the type and the label of the corresponding background pattern configuration file of the icon numbered currentPos+numcols in the grid view, i.e., the fourth icon, are the same as the type and the label of the corresponding background pattern configuration file of the target icon, respectively, and acquires the detecting result as the correlation between the target icon and the fourth icon.

The smart phone may search the corresponding relation between the correlation and the vertical position of the target icon in the grid view, according to the correlation between the target icon and the third icon and the correlation between the target icon and the fourth icon, to determine the vertical position of the target icon in the grid view.

Assume the target icon has four types of vertical positions in the grid view: M, F, L, and S. M means that the target icon is in a middle position among a plurality of adjacent icons of the same type displayed in the same column in the grid view (middle). F means that the target icon is in a first position among a plurality of adjacent icons of the same type displayed in the same column in the grid view (first). L means that the target icon is in a last position among a plurality of adjacent icons of the same type displayed in the same column in the grid view (last). S means that the target icon has no adjacent icons of the same type either above or below it in the grid view (single). The relation between the correlations and the vertical position of the target icon is shown in Table 2.

TABLE 2

| Correlation between | Correlation between target | Vertical position |
|---|---|---|
| target icon and third icon | icon and fourth icon | of target icon |
| same | same | M |
| same | different | L |
| different | same | F |
| different | different | S |

When the target icon is in the first column in the grid view, no corresponding first icon exists, and it is considered that the attribute information of the target icon and the attribute information of the first icon are different. When the target element is in the last column of the grid view, no corresponding second icon exists, and it is considered that the attribute information of the target element and the attribute information of the second icon are different. Similarly, when the target icon is in the first line of the grid view, no corresponding third icon exists, and it is considered that the attribute information of the target icon and the attribute information of the third icon are different. When the target element is in the last line of the grid view, no corresponding fourth icon exists, and it is considered that the attribute information of the target element and the attribute information of the fourth icon are different.

The electronic device may first determine the line number of the target element in the grid view, and then determine whether the target element is in the first or the last line of the grid view according to the line number of the target element and the total number of lines in the grid view. Similarly, the electronic device may first determine the column number of the target element in the grid view, and then determine whether the target element is in the first or the last column of the grid view according to the column number of the target element and the total number of columns in the grid view.

To determine the line number and the column number of the target element, the electronic device divides currentPos of the target element by numcols. The quotient of this division is the line number and the remainder is the column number.

Referring again to FIG. 1, in some embodiments, determining the background pattern information corresponding to the target element in 104 includes a determination according to the position of the target element in the grid view and the background pattern configuration file. The background pattern configuration file includes the corresponding relation between the horizontal and vertical positions of the target element in the grid view and the background pattern information corresponding to the target element. For example, if the elements in the grid view are icons displayed in a smart phone according to the grid view, icons in the grid view that are of different types may correspond to different background pattern configuration files or the same background pattern configuration file.

Table 3 below is a typical example of the content of a background pattern configuration file containing the corresponding relation between the horizontal and vertical positions of the target element in the grid view and the label of the corresponding background pattern. In some embodiments, each background pattern configuration file may have a unique ID label, and the background pattern information for different positions in the background pattern configuration file may be different from each other. As shown in Table 3, the elements in the grid view may at most correspond to 16 types of different background patterns according to different horizontal positions and vertical positions.

TABLE 3

| | | | | | | | | |
|---|---|---|---|---|---|---|---|---|
| Horizontal | M | M | M | M | F | F | F | F |
| position | | | | | | | | |
| Vertical | M | F | L | S | M | F | L | S |
| position | | | | | | | | |
| Background | Pattern 1 | Pattern 2 | Pattern 3 | Pattern 4 | Pattern 5 | Pattern 6 | Pattern 7 | Pattern 8 |
| pattern | | | | | | | | |
| Horizontal | L | L | L | L | S | S | S | S |
| position | | | | | | | | |
| Vertical | M | F | L | S | M | F | L | S |
| position | | | | | | | | |
| Background | Pattern 9 | Pattern 10 | Pattern 11 | Pattern 12 | Pattern 13 | Pattern 14 | Pattern 15 | Pattern 16 |
| pattern | | | | | | | | |

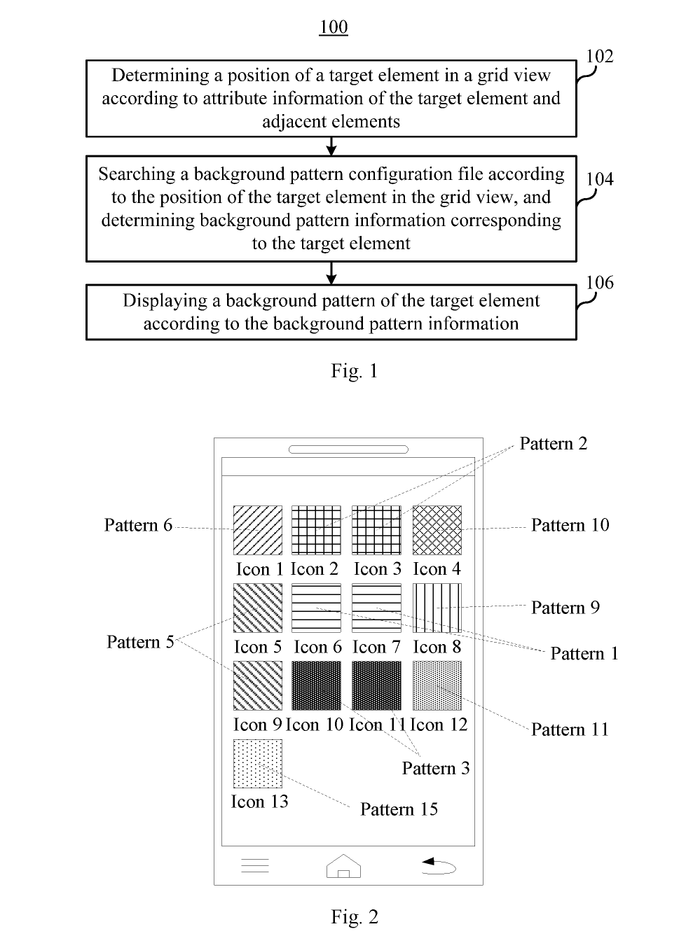

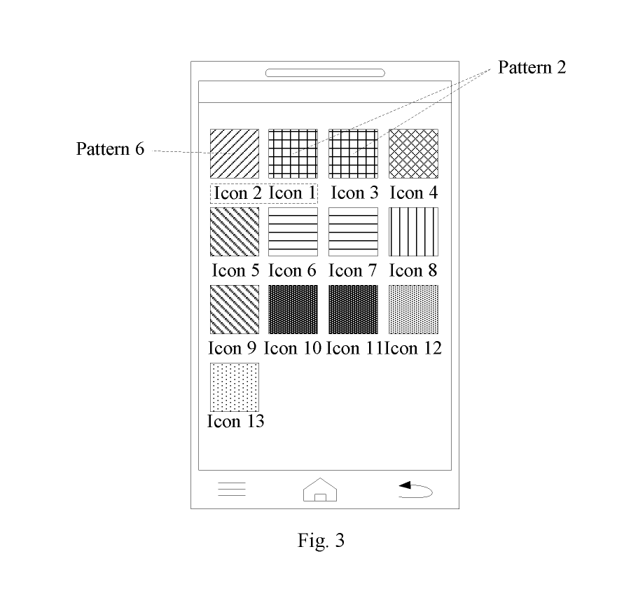

If the elements in the grid view are icons, as shown in FIG. 2, the icons displayed on the smart phone screen according to the grid view include thirteen icons arranged in four lines and four columns. The last line has only one icon. The type and the corresponding background pattern configuration file of each icon are the same as those of other icons. The horizontal and vertical positions of Icon 1 are both F. According to Table 3, the displayed background pattern of Icon 1 is Pattern 6. Further, the horizontal positions of Icon 2 and Icon 3 are both M, and the vertical positions thereof are both F. According to Table 3, the displayed background patterns for both Icon 1 and Icon 3 are Pattern 2. Similarly, the background pattern of Icon 4 is Pattern 10, the background patterns of Icon 5 and Icon 8 are Pattern 5, the background patterns of Icon 6 and Icon 7 are Pattern 1, the background pattern of Icon 8 is Pattern 9, the background patterns of Icon 10 and Icon 11 are Pattern 3, the background pattern of Icon 12 is Pattern 11, and the background pattern of Icon 13 is Pattern 15.

The number of positions in the grid view may be limited, e.g., to 16 different positions as described above. Therefore, the developer only needs to designate the background pattern information for each position in the grid view instead of designating background pattern information for each element in the grid view. As a result, the workload of the developer is reduced.

Sometimes the elements in the grid view may change. For example, in some circumstances, the user may define the positions of the elements, such as exchanging positions of Icon 1 and Icon 2 shown in FIG. 3. In FIG. 3, the horizontal and vertical positions of Icon 2 are both F, and the displayed background pattern thereof is Pattern 6 according to Table 3. Similarly, the horizontal and vertical positions of Icon 1 are M and F, respectively, and the displayed background pattern thereof is Pattern 2 according to Table 3. The patterns for the other icons are the same as those shown in FIG. 2.

In some embodiments, when determining the horizontal position of the target element in the grid view, the electronic device may search a predetermined first correlation information, which indicates whether the attribute information of the target element and the attribute information of the first element are the same, and whether the attribute information of the target element and the attribute information of the second element are the same. The electronic device determines the correlation between the target element and the first element and the correlation between the target element and the second element according to the first correlation information. Similarly, when determining the correlation between the target element and the third element and the correlation between the target element and the fourth element, the electronic device may further search a predetermined second correlation information, which indicates whether the attribute information of the target element and the attribute information of the third element are the same, and whether the attribute information of the target element and the attribute information of the fourth element are the same. The electronic device determines the correlation between the target element and the third element and the correlation between the target element and the fourth element according to the second correlation information.

In some embodiments, the electronic device may preset and store the correlations between the target element and the first element, between the target element and second element, between the target element and third element, and between the target element and fourth element. The electronic device directly searches the stored correlations, and determines the horizontal and vertical positions of the target element in the grid view according to the searched result and Table 1 or Table 2.

In some embodiments, the electronic device may further display a setting interface to the user, and determine the correlation between the target element and the corresponding first, second, third, or fourth element according to the selection of the user in the setting interface. For example, the electronic device may provide the user with an open interface for the user to select whether the attribute information of each target element and the attribute information of its horizontally preceding element, horizontally following element, upper element, or lower element are the same or not. That is, the user may define the value corresponding to each target element in Table 1 and Table 2, thereby making the background pattern of each element displayed in the grid view settable according to the user's desire.

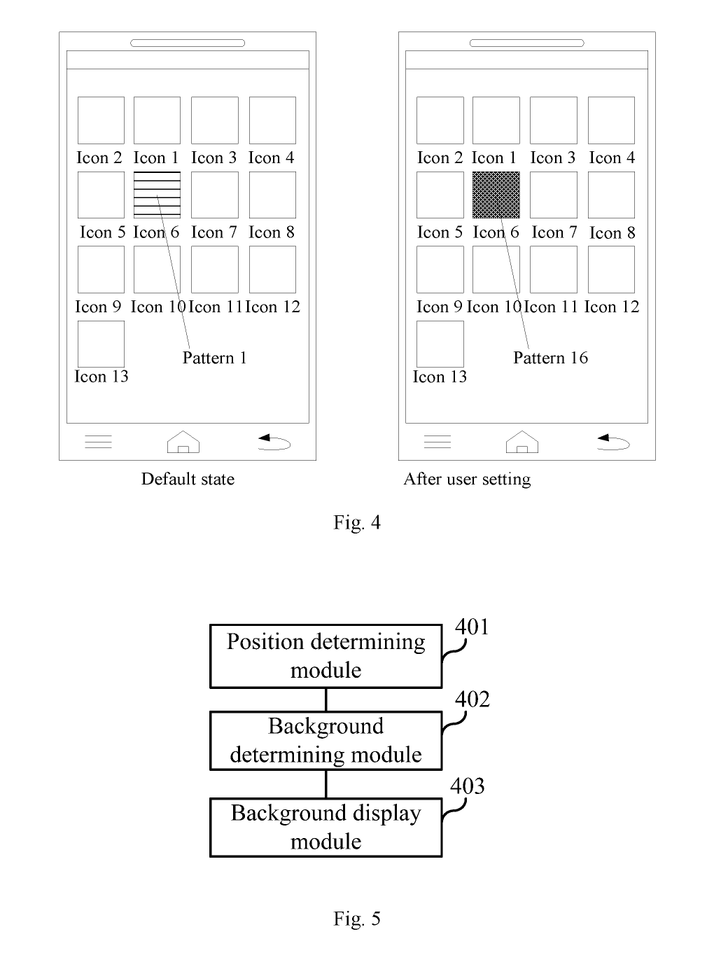

If the elements are icons displayed according to the grid view in the smart phone, the electronic device provides a correlation setting interface for setting the attribute information of each icon, in which the user may set whether a display state of each element is the same or different as compared to the display state of its horizontally preceding, horizontally following, upper, or lower element. FIG. 4 illustrates the effect of setting the attribute information. By default, the attribute information of Icon 6 is the same as the attribute information of Icon 5, Icon 7, Icon 1, and Icon 10. In this scenario, the background pattern of Icon 6 is determined to be Pattern 1 according to Table 3, as shown in the left panel of FIG. 4. If the user, by using the correlation setting interface, modifies and makes the relations between the attribute information of Icon 6 and the attribute information of Icon 5, Icon 7, Icon 1, and Icon 10 different, the displayed background pattern of Icon 6 is determined to be pattern 16 according to Table 3, as shown in the right panel of FIG. 4.

FIG. 5 is a schematic diagram of an exemplary background display device consistent with embodiments of the disclosure. The background display device shown in FIG. 5 may be configured to execute methods consistent with embodiments of the disclosure, such as the background display methods described above in connection with FIG. 1. The background display device shown in FIG. 5 includes a position determining module 401, a background determining module 402, and a background display module 403.

The position determining module 401 is configured to determine a position of a target element in a grid view according to attribute information of the target element and attribute information of adjacent elements. The target element is one of several elements displayed according to the grid view.

The background determining module 402 is configured to search a background pattern configuration file according to the position of the target element in the grid view, and to determine background pattern information corresponding to the target element.

The background display module 403 is configured to display a background pattern of the target element according to the background pattern information.

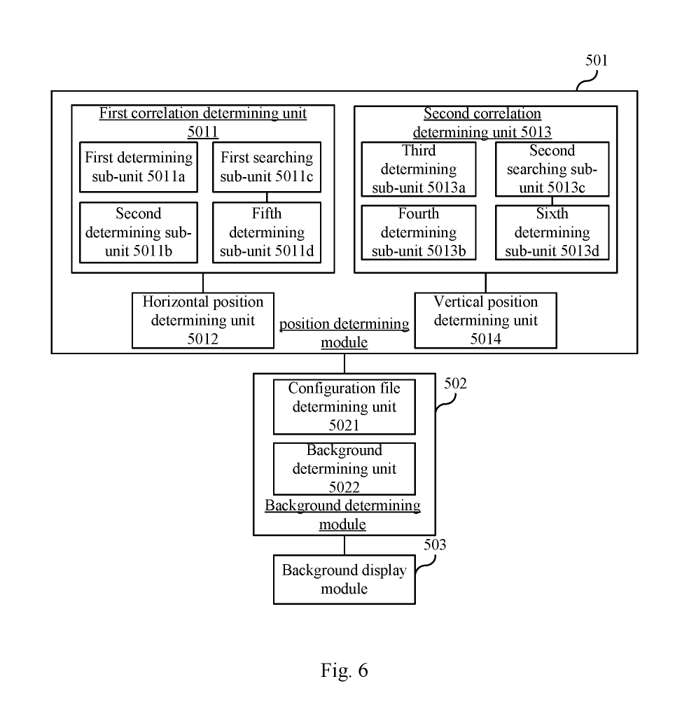

FIG. 6 is a schematic diagram of an exemplary background display device consistent with embodiments of the disclosure. The background display device shown in FIG. 6 may be configured to execute methods consistent with embodiments of the disclosure, such as the background display methods described above in connection with FIG. 1. The background display device shown in FIG. 6 includes a position determining module 501, a background determining module 502, and a background display module 503.

The position determining module 501 is configured to determine a position of a target element in a grid view according to attribute information of the target element and attribute information of adjacent elements. The target element is one of several elements displayed according to the grid view.

The background determining module 502 is configured to search a background pattern configuration file according to the position of the target element in the grid view, and to determine background pattern information corresponding to the target element.

The background display module 503 is configured to display a background pattern of the target element according to the background pattern information.

The position determining module 501 includes a first correlation determining unit 5011, a horizontal position determining unit 5012, a second correlation determining unit 5013, and a vertical position determining unit 5014.

The first correlation determining unit 5011 is configured to determine a correlation between the target element and a first element and the correlation between the target element and a second element. A correlation between two elements includes whether the attribute information of the two elements is the same or different. As explained above, the first element is an element that is nearest to the target element among those elements on the left side of the target element. The second element is an element that is nearest to the target element among those elements on the right side of the target element.

The horizontal position determining unit 5012 is configured to search a corresponding relation between the correlation and the horizontal position of the target element in the grid view, according to the correlation between the target element and the first element and the correlation between the target element and the second element, to determine the horizontal position of the target element in the grid view.

The second correlation determining unit 5013 is configured to determine the correlation between the target element and a third element and the correlation of the target element and a fourth element. As explained above, the third element is an element that is nearest to the target element among those elements above the target element. The fourth element is an element that is nearest to the target element among those elements below the target element.

The vertical position determining unit 5014 is configured to search the corresponding relation between the correlation and the vertical position of the target element in the grid view, according to the correlation between the target element and the third element and the correlation between the target element and the fourth element, to determine the vertical position of the target element in the grid view.

The first correlation determining unit 5011 includes a first determining sub-unit 5011a and a second determining sub-unit 5011b. The first determining sub-unit 5011a is configured to determine that attribute information of the target element and attribute information of the first element are different when the attribute information of the first element is null. The second determining sub-unit 5011b is configured to determine that the attribute information of the target element and the attribute information of the second element are different when the attribute information of the second element is null.

The second correlation determining unit 5013 includes a third determining sub-unit 5013a and a fourth determining sub-unit 5013b. The third determining sub-unit 5013a is configured to determine that the attribute information of the target element and the attribute information of the third element are different when the attribute information of the third element is null. The fourth determining sub-unit 5013b is configured to determine that the attribute information of the target element and the attribute information of the fourth element are different when the attribute information of the fourth element is null.

As shown in FIG. 6, the first correlation determining unit 5011 further includes a first searching sub-unit 5011c and a fifth determining sub-unit 5011d. The first searching sub-unit 5011c is configured to search predetermined first correlation information, which indicates whether the attribute information of the target element and the attribute information of the first element are the same, and whether the attribute information of the target element and the attribute information of the second element are the same.

The fifth determining sub-unit 5011d is configured to determine the correlation between the target element and the first element and the correlation between the target element and the second element, according to the first correlation information.

The second correlation determining unit 5013 further includes a second searching sub-unit 5013c and a sixth determining sub-unit 5013d. The second searching sub-unit 5013c is configured to search predetermined second correlation information, which indicates whether the attribute information of the target element and the attribute information of the third element are the same, and whether the attribute information of the target element and the attribute information of the fourth element are the same. The sixth determining sub-unit 5013d is configured to determine the correlation between the target element and the third element and the correlation between the target element and the fourth element, according to the second correlation information.

The background determining module 502 includes a configuration file determining unit 5021 and a background determining unit 5022. The configuration file determining unit 5021 is configured to determine the background pattern configuration file corresponding to the target element. The background pattern configuration file includes a corresponding relation between each position in the grid view and the background pattern information of that position. The background determining unit 5022 is configured to search the background pattern configuration file according to the position of the target element in the grid view, and determine the background pattern information corresponding to the target element.

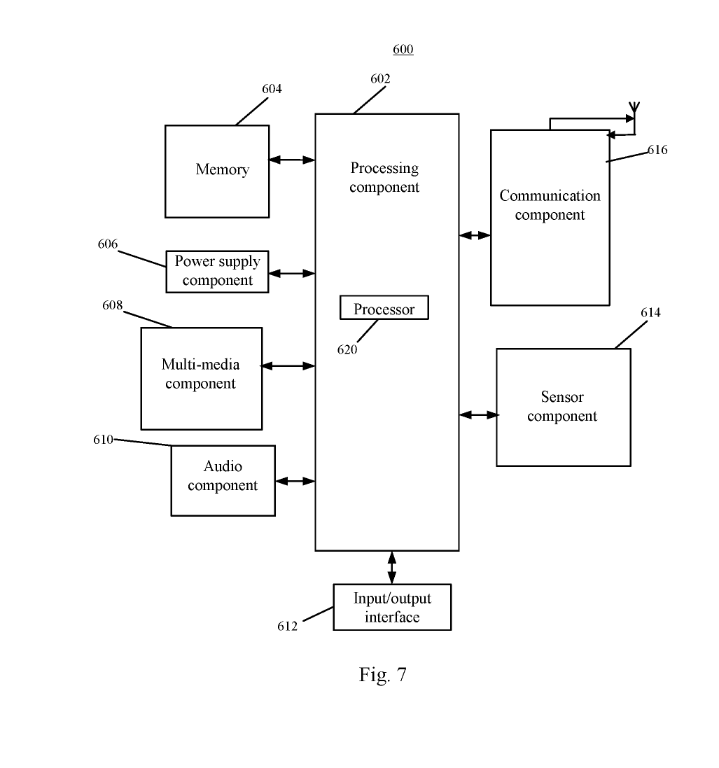

FIG. 7 is a block diagram of an exemplary electronic device 600 consistent with embodiments of the disclosure. The electronic device 600 may be, for example, a mobile phone, a computer, a digital broadcast terminal, a message sending and receiving device, a game control center, a flat computer device, a medical device, a fitness device, a personal digital assistance and so on.

As show in FIG. 7, the electronic device 600 includes a processing component 602, a memory 604, a power supply component 606, a multi-media component 608, an audio component 610, an input/output (I/O) interface 612, a sensor component 614, and a communication component 616.

The processing component 602 usually controls the operation of the electronic device 600 such as operations relating to display, making call, digital communication, taking photos, and recording. The processing component 602 includes one or more processors 620 to execute instructions to finish all or part of the methods consistent with embodiments of the disclosure. Besides, the processing component 602 may include one or more modules for facilitating the interaction between the processing component 602 and other components. For example, the processing component 602 may include a multi-media module to facilitate the interaction between the multi-media component 608 and the processing component 602.

The memory 604 is configured to store various kinds of data to support the operation of the electronic device 600. Examples of the data may include any instructions for performing applications or methods at the electronic device 600, contact data, phone book data, messages, figures, videos and so on. The memory 604 may be any type of volatile or non-volatile storage device or combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, or magnetic disk or compact disk. The memory 604 further stores one or more instructions that, when executed by the one or more processors 620, cause the processors 620 to finish all or part of the methods consistent with embodiments of the disclosure.

The power supply component 606 provides power for components of the electronic device 600. The power supply component 606 may include a power supply management system, one or more power supplies, and other related components for generating, managing, and distributing power for the electronic device 600.

The multi-media component 608 includes a screen which provides an output interface between the electronic device 600 and the user. In some embodiments, the screen may include a liquid crystal display (LCD) and a touch panel (TP). If the screen includes a touch panel, the screen may be realized to be a touch screen to receive input signals from the user. The touch panel includes one or more touch sensors to sense touch, slide and gestures on the touch panel. The touch sensor may not only sense the touch or slide boundary, but also detect the duration time and pressure of the touch or slide operation. In some embodiments, the multi-media component 608 includes a front camera and/or a back camera. When the electronic device 600 is in an operation mode, such as photo mode or video mode, the front camera and/or the back camera may receive outside multi-media data. Each of the front camera and back camera may be a fixed optical lens system or have the focal length and optical zoom ability.

The audio component 610 is configured to output and/or input audio signals. For example, the audio component 610 includes a microphone (MIC). When the electronic device 600 is in an operation mode such as a calling mode, a record mode and a voice recognition mode, the microphone is configured to receive outside audio signals. The received audio signal may be further stored in the memory 604 or sent by the communication component 616. In some embodiments, the audio component 610 may further include a loudspeaker for outputting audio signals.

The I/O interface 612 may provide an interface between the processing component 602 and peripheral interface modules. The peripheral interface modules may be a keyboard, a click wheel, a button and so on. These buttons include but do not limited to a homepage button, a volume button, a start button, or a lock button.

The sensor component 614 includes one or more sensors for evaluating state of different aspects of the electronic device 600. For example, the sensor component 614 may detect the on/off state of the electronic device 600, and the relative locations of components, for example, the components are display and keypad of the electronic device 600. The sensor component 614 may further sense the position change of the electronic device 600 or the position change of component of the electronic device 600, whether the contact exists between the user and the electronic device 600, the orientation of the electronic device 600, the acceleration/deceleration of the electronic device 600, and the temperature change of the electronic device 600. The sensor component 614 may include a proximity sensor which is configured for detecting the existence of nearby substance when no physical contact exists. The sensor component 614 may further include a light sensor such as CMOS or CCD image sensor, for using in imaging applications. In some embodiments, the sensor component 614 further includes an accelerate sensor, a gyro sensor, a magnetic sensor, a pressure sensor or a temperature sensor.

The communication component 616 is configured to communicate between the electronic device 600 and other devices in a wired or wireless manner. The electronic device 600 may be connected to a wireless network based on a communication standard such as wireless fidelity (WiFi), 2G or 3G or their combinations. In an exemplary embodiment, the communication component 616 receives broadcast signal or broadcast related information from outside broadcast management system via broadcast channel. In an exemplary embodiment, the communication component 616 further includes a near field communication (NFC) module to prompt short range communication. For example, the NFC module may be achieved based on radio frequency identification (RFID) technology, infrared data association (IrDA) technology, ultra-wide bandwidth (UWB) technology, Bluetooth (BT) technology and other technologies.

In exemplary embodiments, the electronic device 600 may be implemented by one or more of application specific integrated circuit (ASIC), digital signal processor (DSP), digital signal processor device (DSPD), programmable logic device (PLD), field programmable gate array (FPGA), controller, micro controller, micro-processor or other electronic elements, for executing the methods consistent with embodiments of the disclosure.

In exemplary embodiments, a non-transitory computer-readable storage medium storing instructions is provided, such as the memory 604 storing instructions. The instructions may be executed by the one or more processors 620 of the electronic device 600 to perform the methods consistent with embodiments of the disclosure. For example, the non-transitory computer-readable storage medium may be ROM, random access memory (RAM), CD-ROM, magnetic tape, soft disk and optical data storage devices, etc.

According to the disclosure, the background pattern of the target element is determined by the position of the target element in the grid view. Therefore, the developer only needs to designate the background pattern information for each position of the grid view, instead of designating the background pattern information for each element. As a result, the workload of the developer is reduced, the developing period is shortened, and the developing and maintaining cost is decreased while an aesthetic and vivid interface is obtained.

Those skilled in the art may conceive other embodiments that are not specifically described in the present disclosure. This application is intended to cover any variations, uses, or adaptations consistent with the present disclosure. These variations, uses, or adaptations follow general principles of the present disclosure, and include undisclosed common knowledge or customary technical means in the art. The specification and embodiments are considered exemplary only, and the true scope and spirit of the present disclosure are indicated by the claims.

It should be understood that, the present disclosure is not limited to the above described exact structure illustrated in the accompanying drawings, and may have various modifications and changes without departing from the scope thereof. It is intended that the scope of the invention only be limited by the appended claims.

What is claimed is:

1. A background display method, comprising:
determining a position of a target element in a grid view according to attribute information of the target element and attribute information of adjacent elements, the target element being one of a plurality of elements displayed according to the grid view;
searching a background pattern configuration file according to the position of the target element to determine background pattern information corresponding to the target element; and
displaying a background pattern of the target element according to the background pattern information corresponding to the target element.

2. The method according to claim 1, wherein determining the position of the target element includes:
determining a first correlation between the target element and a first element and a second correlation between the target element and a second element, the first element being one of the adjacent elements that is on a left side of the target element, and the second element being one of the adjacent elements that is on a right side of the target element;
determining a horizontal position of the target element in the grid view according to the first and second correlations;
determining a third correlation between the target element and a third element and a fourth correlation between the target element and a fourth element, the third element being one of the adjacent elements that is above the target element, and the fourth element being one of the adjacent elements that is below the target element; and
determining a vertical position of the target element in the grid view according to the third and fourth correlations.

3. The method according to claim 2, wherein:
determining the first correlation and the second correlation includes:
determining that the attribute information of the target element and the attribute information of the first element are different if the attribute information of the first element is null; and
determining that the attribute information of the target element and the attribute information of the second element are different if the attribute information of the second element is null; and
determining the third correlation and the fourth correlation includes:
determining that the attribute information of the target element and the attribute information of the third element are different if the attribute information of the third element is null; and
determining that the attribute information of the target element and the attribute information of the fourth element are different if the attribute information of the fourth element is null.

4. The method according to claim 2, wherein:
determining the first correlation and the second correlation includes:
searching preset first correlation information, the first correlation information indicating whether the attribute information of the target element and the attribute information of the first element are the same, and whether the attribute information of the target element and the attribute information of the second element are the same; and
determining the first correlation and the second correlation according to the first correlation information; and
determining the third correlation and the fourth correlation includes:
searching preset second correlation information, the second correlation information indicating whether the attribute information of the target element and the attribute information of the third element are the same, and whether the attribute information of the target element and the attribute information of the fourth element are the same; and
determining the third correlation and the fourth correlation according to the second correlation information.

5. The method according to claim 1, wherein searching the background pattern configuration file includes searching a background pattern configuration file that includes corresponding relations between positions in the grid view and background pattern information of the positions.

6. An electronic device, comprising:
one or more processors; and
a non-transitory computer-readable storage medium storing instructions that, when executed by the one or more processors, cause the one or more processors to:
determine a position of a target element in a grid view according to attribute information of the target element and attribute information of adjacent elements, the target element being one of a plurality of elements displayed according to the grid view;
search a background pattern configuration file according to the position of the target element to determine background pattern information corresponding to the target element; and
display a background pattern of the target element according to the background pattern information.

7. The electronic device according to claim 6, wherein the instructions causing the one or more processors to determine the position of the target element include instructions causing the one or more processors to:
determine a first correlation between the target element and a first element and a second correlation between the target element and a second element, the first element being one of the adjacent elements that is on a left side of the target element, and the second element being one of the adjacent elements that is on a right side of the target element;
determine a horizontal position of the target element in the grid view according to the first and second correlations;
determine a third correlation between the target element and a third element and a fourth correlation between the target element and a fourth element, the third element being one of the adjacent elements that is above the target element, and the fourth element being one of the adjacent elements that is below the target element; and
determine a vertical position of the target element in the grid view according to the third and fourth correlations.

8. The electronic device according to claim 7, wherein:
the instructions causing the one or more processors to determine the first correlation and the second correlation include instructions causing the one or more processors to:
determine that the attribute information of the target element and the attribute information of the first element are different if the attribute information of the first element is null; and
determine that the attribute information of the target element and the attribute information of the second element are different if the attribute information of the second element is null; and
the instructions causing the one or more processors to determine the third correlation and the fourth correlation include instructions causing the one or more processors to:
determine that the attribute information of the target element and the attribute information of the third element are different if the attribute information of the third element is null; and
determine that the attribute information of the target element and the attribute information of the fourth element are different if the attribute information of the fourth element is null.

9. The electronic device according to claim 7, wherein:
the instructions causing the one or more processors to determine the first correlation and the second correlation include instructions causing the one or more processors to:
search preset first correlation information, the first correlation information indicating whether the attribute information of the target element and the attribute information of the first element are the same, and whether the attribute information of the target element and the attribute information of the second element are the same; and
determine the first correlation and the second correlation according to the first correlation information; and
the instructions causing the one or more processors to determine the third correlation and the fourth correlation include instructions causing the one or more processors to:
search preset second correlation information, the second correlation information indicating whether the attribute information of the target element and the attribute information of the third element are the same, and whether the attribute information of the target element and the attribute information of the fourth element are the same; and
determine the third correlation and the fourth correlation according to the second correlation information.

10. The electronic device according to claim 6, wherein the instructions causing the one or more processors to search the background pattern configuration file include instructions causing the one or more processors to search a background pattern configuration file that includes a corresponding relation between a position in the grid view and background pattern information of the position.

11. A non-transitory computer-readable storage medium having stored therein instructions that, when executed by one or more processors of an electronic device, cause the electronic device to:
determine a position of a target element in a grid view according to attribute information of the target element and attribute information of adjacent elements, the target element being one of a plurality of elements displayed according to the grid view;
search a background pattern configuration file according to the position of the target element to determine background pattern information corresponding to the target element; and
display a background pattern of the target element according to the background pattern information corresponding to the target element.
